(19) United States
(12) Patent Application Publication
(10) Pub. No.: US 2020/0224053 A1
(43) Pub. Date: Jul. 16, 2020

(54) COATING COMPOSITIONS INCLUDING A RESOLE PHENOLIC RESIN, ARTICLES, AND METHODS OF COATING

(71) Applicant: SWIMC LLC, Cleveland, OH (US)

(72) Inventors: Ben Webster, Pittsburgh, PA (US); Richard Evans, Wexford, PA (US); Robert O'Brien, Monongahela, PA (US); Joseph Desousa, Pittsburgh, PA (US); Kailas Sawant, Mars, PA (US); Gregory M. Paulson, Evans City, PA (US); Adrienne Robey, Shinnston, WV (US); Yingchao Zhang, Murrysville, PA (US)

(21) Appl. No.: 16/648,616

(22) PCT Filed: Sep. 17, 2018
(86) PCT No.: PCT/US2018/051316

§ 371 Date: Mar. 18, 2020

Related U.S. Application Data
(60) Provisional application No. 62/560,421, filed on Sep. 19, 2017.

(51) Int. Cl. C09D 171/12; B65D 65/42

(52) U.S. Cl. CPC C09D 171/12; B65D 65/42

(57) ABSTRACT

A food or beverage container coating composition, coated article, and method of coating, wherein the coating composition comprises: a film-forming polymer; and a resole phenolic resin comprising the reaction product of components comprising an aldehyde and a phenol group-containing compound, wherein the phenol group-containing compound comprises one or more phenyl rings (preferably, two or more phenyl rings), at least two hydroxy groups, each of which is directly bonded to the one or more phenyl rings, and at least four (preferably, at least five) open sites ortho and/or para to the hydroxy groups; wherein the composition is thermally curable.

### CROSS-REFERENCE TO RELATED APPLICATIONS

The present application claims the benefit of U.S. Provisional Application Ser. No. 62/560,421, filed on Sep. 19, 2017, the entirety of which is incorporated herein by reference.

### BACKGROUND

Various coatings have been used as interior protective container coatings, including mobile or bound bisphenol A (BPA), bisphenol F (BPF), bisphenol S (BPS), or aromatic glycidyl ether compounds thereof (e.g., the diglycidyl ether of BPA, BPF, or BPS). Although the balance of scientific evidence available to date indicates that trace amounts of these compounds that might be released from existing coatings do not pose health risks to humans, these compounds are nevertheless perceived by some consumers as being potentially harmful to human health. To address the aforementioned shortcomings, the packaging coatings industry has sought alternative coatings.

The balance of coating performance attributes required for a coating composition to be suitable for use as a food or beverage container coating are particularly stringent and are unique from other coating end uses. As such, coatings designed for other end uses are not typically suitable for use as food or beverage container coatings.

For example, coatings for use on food or beverage containers should avoid unsuitably altering the taste of the packaged food or beverage products, and should also avoid flaking or chipping into the packaged products. The coatings should also resist chemically aggressive food or beverage products (which can have a complex chemical profile, including salts, acids, sugars, fats, etc.) for extended periods of time (e.g., years). Food or beverage container coatings should also have good adhesion to the underlying substrate and remain sufficiently flexible after curing. This is because subsequent fabrication and denting during transportation, storage, or use (e.g., by dropping) may cause the metal substrate to deform, which will cause the coating to flex. A brittle coating will crack during flexure, exposing the container metal to the packaged products, which can sometimes cause a leak in the container. Even a low probability of coating failure may cause a significant number of containers to leak, given the high number of food and beverage containers produced.

Various coatings have been used as protective food or beverage container coatings, including epoxy coatings and polyvinyl-chloride-based coatings. Each of these coating types, however, has potential shortcomings. For example, the recycling of materials containing polyvinyl chloride or related halide-containing vinyl polymers can be problematic. There is also a desire by some to reduce or eliminate certain epoxy compounds (e.g., bisphenol A) commonly used to formulate food-contact epoxy coatings. Although a number of replacement coating compositions made without such materials have been proposed, some replacement compositions have exhibited insufficient coating properties such as insufficient corrosion resistance on metal substrates, insufficient flexibility, or insufficient toughness.

To address the aforementioned shortcomings, the packaging coatings industry has sought coatings based on alternative binder systems such as polyester resin systems, for example. It has been problematic, however, to formulate polyester-based coatings that exhibit the required balance of coating characteristics (e.g., flexibility, adhesion, corrosion resistance, stability, resistance to crazing, etc.). For example, there has typically been a tradeoff between corrosion resistance and fabrication properties for such coatings. Polyester-based coatings suitable for food-contact that have exhibited both good fabrication properties and an absence of crazing have tended to be too soft and exhibit unsuitable corrosion resistance. Conversely, polyester-based coatings suitable for food contact that have exhibited good corrosion resistance have typically exhibited poor flexibility and unsuitable crazing when fabricated.

Accordingly, it will be appreciated that what is needed in the art are improved coating compositions that are made without intentionally using bisphenol A, but which exhibit the stringent balance of coating properties to permit the use of such coating compositions on food or beverage containers.

### SUMMARY OF THE DISCLOSURE

The present disclosure provides food or beverage container coating compositions, articles having a coating formed from such compositions, and methods of coating.

In one embodiment, a food or beverage container coating composition is provided that includes: a film-forming polymer; and a resole phenolic resin (that is distinct from the film-forming polymer). The resole phenolic resin includes the reaction product of components including an aldehyde and a phenol group-containing compound. The phenol group-containing compound includes one or more phenyl rings (preferably, two or more phenyl rings), at least two hydroxy groups, each of which is directly bonded to the one or more phenyl rings, and at least four (preferably, at least five) open sites ortho and/or para to the hydroxy groups. The coating composition is thermally curable, and in certain embodiments, the composition has a viscosity of 25 cps (25 mPa·s) to 1000 cps (1000 mPa·s). In certain embodiments, the film-forming polymer is present in a majority amount (greater than 50 wt-% film-forming polymer), based on the total weight of the film-forming polymer and the resole phenolic resin, although there are embodiments in which there may be little or no film-forming polymer distinct from the resole phenolic resin.

In another embodiment, a food or beverage container is provided that includes a metal substrate having a surface (preferably, an inside surface) at least partially coated with a coating including the reaction product of components that include a film-forming polymer and a resole phenolic resin as disclosed herein.

In another embodiment, a method is provided that includes: providing a coating composition as described herein; applying the coating composition to at least a portion of a metal substrate prior to or after forming the metal substrate into a food or beverage container or portion thereof; and thermally curing the coating composition.

The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” in dicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other claims are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 20° C. to 25° C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Although various theories and possible mechanisms may have been discussed herein, in no event should such discussions serve to limit the claimable subject matter.

### DETAILED DESCRIPTION OF ILLUSTRATIVE EMBODIMENTS

The present disclosure provides food or beverage container coating compositions, articles having a coating formed from such compositions, and methods of coating. Herein, a food or beverage “container” is used to encompass containers such as pails or drums in additional to conventional cans.

In one embodiment, a food or beverage container coating composition is provided that includes: a film-forming polymer; and a resole phenolic resin (distinct from the film-forming polymer). In certain embodiments, the film-forming polymer is present in a majority amount (greater than 50 wt-% film-forming polymer), based on the total weight of the film-forming polymer and the resole phenolic resin, although there are embodiments in which there may be little or no film-forming polymer distinct from the resole phenolic resin

The resole phenolic resin includes the reaction product of components including an aldehyde and a phenol group-containing compound. Preferably, the resole phenolic resin is a crosslinker. As used herein, “crosslinker” refers to molecules capable of forming a covalent linkage between polymers or between two different regions of the same polymer. It may also refer to self-crosslinking that can occur when the starting resole phenolic includes monomers or oligomers.

Although such coating compositions can be used for beverage containers, they are preferably used for food containers, particularly as an internal coating (e.g., inside spray coating) of a food can. Thus, in one embodiment of the present disclosure, a food or beverage container (preferably, a food container such as a food can) is provided that includes a metal substrate having a surface (an exterior or interior surface, preferably, an interior (i.e, inside) surface) at least partially coated with a coating including the reaction product of components that include a film-forming polymer and a resole phenolic resin as disclosed herein.

The phenolic compound is a resole phenolic resin as opposed to a novolac phenolic resin, which are distinct as a result of different reaction conditions (e.g., ratio of reactants and catalyst). A resole phenolic resin is a base-catalyzed resin with an aldehyde (typically, formaldehyde) to phenol group-containing compound molar ratio of greater than one (e.g., 1.5). In contrast, a novolac phenolic resin is an acid-catalyzed resin with an aldehyde (typically, formaldehyde) to phenol group-containing compound molar ratio of less than one.

The resole phenolic resin used herein can be formed from a phenol group-containing compound that is itself a novolac phenolic resin. That is, the phenol group-containing compound can be prepared from an acid-catalyzed system.

In certain embodiments, the resole phenolic resin is present in an amount of at least 0.5 wt-%, or at least 1.0 wt-%, based on the total weight of the film-forming polymer and the resole phenolic resin. In certain embodiments, the resole phenolic resin is present in an amount of up to 30 wt-%, up to 40 wt-%, less than 50 wt-%, up to 50 wt-%, up to 60 wt-%, up to 70 wt-%, up to 80 wt-%, up to 90 wt-%, up to 95 wt-%, up to 98 wt-%, or up to 99.5 wt-%, based on the total weight of the film-forming polymer and the resole phenolic resin. In certain embodiments, the resole phenolic resin is present in an amount of 100 wt-%, and there is no distinct film-forming polymer. In such embodiments, the resole phenolic resin is both the film-former and the crosslinker (i.e., it self crosslinks).

In certain embodiments, the film-forming polymer is present in a majority amount (i.e., greater than 50 wt-%), based on the total weight of the film-forming polymer and the resole phenolic resin. In certain embodiments, the film-forming polymer is present in an amount of at least 60 wt-%, or at least 70 wt-%, based on the total weight of the film-forming polymer and the resole phenolic resin. In certain embodiments, the film-forming polymer is present in an amount of up to 99.5 wt-%, or up to 99.0 wt-%, based on the total weight of the film-forming polymer and the resole phenolic resin. In certain embodiments, the film-forming polymer that is distinct from the resole phenolic resin is not present.

The food and beverage container coating compositions of the present disclosure preferably have a viscosity suitable for a given coating application. Although various application methods are useable, the coating compositions preferably have a viscosity suitable for spray coating.

In certain embodiments, a food or beverage container coating composition of the present disclosure has a viscosity of at least 25 centipoise (cps) (25 mPa·s), or at least 50 mPa·s. In certain embodiments, a food or beverage container coating composition of the present disclosure has a viscosity of up to 1000 mPa·s.

The food or beverage container coating composition of the present disclosure is thermally curable. In this context, thermally curable refers to conditions of temperature and time usually used in container coating lines. In this regard the particular temperature and time ranges are oven temperatures or “PMT” (peak metal temperatures).

In certain embodiments, a food or beverage container coating composition of the present disclosure is thermally curable at a temperature of at least 350° F., or at least 375° F. In certain embodiments, a food or beverage container coating composition of the present disclosure is thermally curable at a temperature of up to 480° F., or up to 450° F.

In certain embodiments, a food or beverage container coating composition of the present disclosure is thermally curable in at least 10 seconds, at least 20 seconds, or in at least 30 seconds. In certain embodiments, a food or beverage container coating composition of the present disclosure is thermally curable within a period of up to 30 minutes, or up to 20 minutes, or up to 10 minutes, or up to 5 minutes.

### Resole Phenolic Resin

The resole phenolic resin of the present disclosure is made in a conventional manner. It is base-catalyzed, using a base such as calcium hydroxide, sodium hydroxide, DMEOA (dimethylethanolamine), and caustic Potash. The aldehyde (typically, formaldehyde) to phenol group-containing compound molar ratio is greater than one. Typically, the aldehyde to phenol group-containing compound molar ratio is at least 1.5, or at least 2. The residual aldehyde of the resole phenolic resins as measured through titration is typically less than 3%. The typical solids range of suitable resole phenolic resins is 50% to 65% with a viscosity in the range of Q-Z1 as measured by Gardner Holdt viscosity. In certain embodiments, the resole phenolic resin typically has a number average molecular weight (Mn) determined by GPC of at least 600 Daltons (Da), or at least 900 Da. In certain embodiments, the resole phenolic resin has an Mn of up to 1200 Da, or up to 1100 Da. The gel time of these resole phenolic resins is typically in the range of 4 minutes to 6 minutes at 150° C. through measurement on a cure plate.

In certain embodiments, the resole phenolic resin is substantially free of bisphenol A, bisphenol F, and bisphenol S, as well as structural units derived therefrom. Preferably, the resole phenolic resin is substantially free of all bisphenol compounds (including non-estrogenic bisphenol compounds), as well as structural units derived therefrom. As used herein, the term “substantially free” means that the resole phenolic resins of the present disclosure contain less than 1000 parts per million (ppm) of bisphenol compound A, bisphenol F, and bisphenol S, as well as structural units derived therefrom (in total), or preferably of all bisphenol compounds, as well as structural units derived therefrom (in total).

As used herein, a bisphenol compound refers to a polyhydric polyphenol having two phenylene groups (i.e., a six-carbon atom aryl ring having any substituent groups including hydrogen atoms, halogens, hydroxyl groups, etc.) that each include six-carbon rings and a hydroxy (—OH) group attached to a carbon atom of the ring, wherein the rings of the two phenylene groups do not share any atoms in common. As used herein, “structural units derived therefrom” includes diepoxide groups of bisphenols, such as in BADGE (Bisphenol A diglycidyl ether).

In certain embodiments, the resole phenolic resin is essentially free of structural units derived from bisphenol A, bisphenol F, and bisphenol S, as well as structural units derived therefrom. In certain preferred embodiments, the resole phenolic resin is essentially free of bisphenol compounds (including non-estrogenic bisphenol compounds), as well as structural units derived therefrom. As used herein, the term “essentially free” means that the resole phenolic resins of the present disclosure contain less than 100 ppm of bisphenol A, bisphenol F, and bisphenol S, as well as structural units derived therefrom (in total), or preferably of all bisphenol compounds, as well as structural units derived therefrom (in total).

In certain embodiments, the resole phenolic resin is essentially completely free of bisphenol A, bisphenol F, and bisphenol S, as well as structural units derived therefrom. In certain preferred embodiments, the resole phenolic resin is essentially completely free from all bisphenol compounds (including non-estrogenic bisphenol compounds), as well as structural units derived therefrom. As used herein, the term “essentially completely free” means that the resole phenolic resins of the present disclosure contain less than 5 ppm of bisphenol A, bisphenol F, and bisphenol S, as well as structural units derived therefrom (in total), or preferably of all bisphenol compounds, as well as structural units derived therefrom (in total).

In certain embodiments, the resole phenolic resin is completely free of bisphenol A, bisphenol F, and bisphenol S, as well as structural units derived therefrom. In certain preferred embodiments, the resole phenolic resin is completely free of all bisphenol compounds (including non-estrogenic bisphenol compounds), as well as structural units derived therefrom.

As used herein, the term “completely free” means that the resole phenolic resins of the present disclosure contain less than 20 parts per billion (ppb) of bisphenol A, bisphenol F, and bisphenol S, as well as structural units derived therefrom (in total), or preferably of all bisphenol compounds, as well as structural units derived therefrom (in total).

### Aldehyde of Resole Phenolic Resin

In certain embodiments, the aldehyde used to make the resole phenolic resin is selected from the group of formaldehyde, acetaldehyde, crotonaldehyde, benzaldehyde, butyraldehyde, cyclohexanecarboxaldehyde, glutaraldehyde, and a combination thereof. In certain embodiments, the aldehyde used to make the resole phenolic resin is formaldehyde.

In certain embodiments, the aldehyde used to make the resole phenolic resin is used in an amount of at least 10.5 wt-% of the weight of the phenol group-containing compound or at least 21.3 wt-% of the weight of the phenol group-containing compound. In certain embodiments, the aldehyde used to make the resole phenolic resin is used in an amount of up to 58.9 wt-% of the weight of the phenol group-containing compound or up to 120.0 wt-% of the weight of the phenol group-containing compound.

### Phenol Group-Containing Compound of the Resole Phenolic Resin

The phenol group-containing compound used to make the resole phenolic resin includes one or more phenyl rings (preferably, two or more phenyl rings) and at least two hydroxy groups, each of which is directly bonded to the one or more phenyl rings, and at least four (preferably at least five) open sites ortho and/or para to the hydroxy groups. In this context, “open sites” on a phenyl ring means that at the ortho and/or para positions to a hydroxyl group, no atoms or groups other than H atoms are attached to ring carbons (i.e., the “sites”). Thus, there are a total of at least four (preferably at least five) C—H groups ortho and/or para to the at least two hydroxy groups directly bonded to a phenyl ring. Such phenol group-containing compound does not include phenol per se.

Typically, there are no heteroatoms in the phenyl rings. Typically, the sites (i.e., ring carbons) that are not “open” may include substituents such as those that are not electron withdrawing.

In certain embodiments, the phenol group-containing compound used to make the resole phenolic resin includes at least three hydroxyphenyl groups (i.e., at least three hydroxy groups, each of which is directly bonded to one or more phenyl rings, such as in trisphenol and tetraphenol).

In certain embodiments, the phenol group-containing compound used to make the resole phenolic resin includes at least three phenyl rings (e.g., trisphenol or tetraphenol).

In certain embodiments, the phenol group-containing compound is selected from the group of:

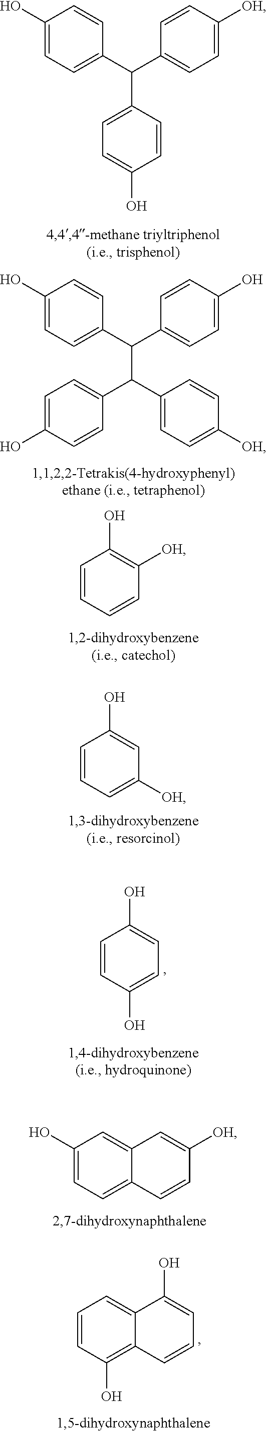

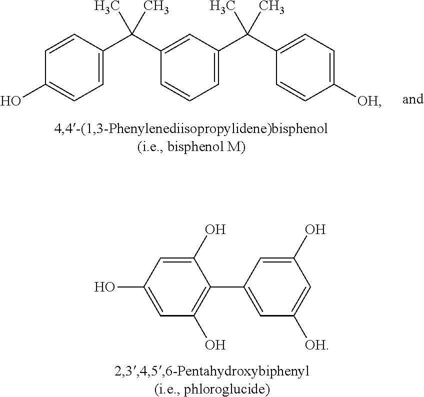 [SMILES: CC(C)(c1ccc(O)cc1)c1cccc(C(C)(C)c2ccc(O)cc2)c1 ; Oc1cc(O)cc(-c2c(O)cc(O)cc2O)c1]

Combinations of such compounds can be used if desired. In certain embodiments, commercially available materials may be mixtures of monomers, dimers, and/or oligomers of each of these compounds.

In certain embodiments, the phenol group-containing compound is selected from the group of trisphenol, tetraphenol, hydroquinone, resorcinol, phloroglucide, 1,5-dihydroxynaphthalene, 2,7-dihydroxynaphthalene, and a combination thereof. In certain embodiments, the phenol group-containing compound is selected from the group of trisphenol, tetraphenol, hydroquinone, and a combination thereof. In certain embodiments, the phenol group-containing compound is selected from the group of trisphenol, tetraphenol, and a combination thereof. In certain embodiments, the phenol group-containing compound is trisphenol.

In certain embodiments, the phenol group-containing compound used to make the resole phenolic resin is used in an amount of at least 45.5 wt-%, or at least 62.9 wt-%, based on the total solids of the resole phenolic resin. In certain embodiments, the phenol group-containing compound used to make the resole phenolic resin is used in an amount of up to 90.5 wt-%, or up to 82.4 wt-%, based on the total solids of the resole phenolic resin.

### Film-Forming Polymer

The polymer used to make a food or beverage container coating composition of the present disclosure is a film-forming polymer. A wide variety of film-forming polymers typically used in the container coating industry can be used in the compositions of the present disclosure. These include, for example, polyethers, polyesters (such as polyester urethanes), acrylics (i.e., acrylates), polyolefins, and combinations thereof (including copolymers thereof such as polyether-acrylics).

In certain embodiments, the film-forming polymer is substantially free of bisphenol A, bisphenol F, and bisphenol S, as well as structural units derived therefrom. Preferably, the film-forming polymer is substantially free of all bisphenol compounds (including non-estrogenic bisphenol compounds), as well as structural units derived therefrom. As used herein, the term “substantially free” means that the film-forming polymers of the present disclosure contain less than less than 1000 parts per million (ppm) of bisphenol A, bisphenol F, and bisphenol S, as well as structural units derived therefrom (in total), or preferably of all bisphenol compounds, as well as structural units derived therefrom (in total).

In certain embodiments, the film-forming polymer is essentially free of bisphenol A, bisphenol F, and bisphenol S, as well as structural units derived therefrom. In certain preferred embodiments, the film-forming polymer is essentially free of all bisphenol compounds (including non-estrogenic bisphenol compounds), as well as structural units derived therefrom. As used herein, the term “essentially free” means that the film-forming polymers of the present disclosure contain less than 100 ppm of bisphenol A, bisphenol F, and bisphenol S, as well as structural units derived therefrom (in total), or preferably of all bisphenol compounds, as well as structural units derived therefrom (in total).

In certain embodiments, the film-forming polymer is essentially completely free of bisphenol A, bisphenol F, and bisphenol S, as well as structural units derived therefrom. In certain preferred embodiments, the film-forming polymer is essentially completely free of structural units derived from all bisphenol compounds (including non-estrogenic bisphenol compounds), as well as structural units derived therefrom. As used herein, the term “essentially completely free” means that the film-forming polymers of the present disclosure contain less than 5 ppm of bisphenol A, bisphenol F, and bisphenol S, as well as structural units derived therefrom (in total), or preferably of all bisphenol compounds, as well as structural units derived therefrom (in total).

In certain embodiments, the film-forming polymer is completely free of bisphenol A, bisphenol F, and bisphenol S, as well as structural units derived therefrom. In certain preferred embodiments, the film-forming polymer is completely free of bisphenol compounds, as well as structural units derived therefrom (including non-estrogenic bisphenol compounds). As used herein, the term “completely free” means that the film-forming polymers of the present disclosure contain less than 20 ppb of bisphenol A, bisphenol F, and bisphenol S, as well as structural units derived therefrom (in total), or preferably of all bisphenol compounds, as well as structural units derived therefrom (in total).

In certain embodiments, the film-forming polymer has a molecular weight (number average) of at least 1,000 Daltons (Da), at least 2,000 Da, or at least 3,000 Da. In certain embodiments, the film-forming polymer has a molecular weight (number average) of up to 20,000 Da, up to 10,000 Da, or up to 7,000 Da. The number-average molecular weight can be determined by gel permeation chromatography (GPC).

In certain embodiments, the film-forming polymer is selected from the group of a polyether, a polyester (e.g., a polyester urethane), an acrylic (i.e., an acrylate), a polyolefin, and a combination thereof (including copolymers thereof, e.g., polyether-acrylic).

Examples of suitable polyether film-forming polymers for use in coating compositions of the present disclosure include those that contain a plurality of aromatic ether segments. The polyether polymer may be formed, for example, from reactants including a polyhydric phenol group-containing compound (more typically a dihydric phenol group-containing compound) and a polyepoxide of a polyhydric phenol group-containing compound (more typically a diepoxide of a dihydric phenol group-containing compound). Such polyether film-forming polymers may include one or more segments having one or more optionally substituted aryl or heteroaryl groups in a backbone portion of the segment. In some embodiments, the one or more such aryl or heteroaryl groups include one or more substituent groups (preferably “bulky” substituent groups) that are attached to the ring preferably at an ortho or meta position, more preferably an ortho position, relative to an oxygen atom attached to the ring, which is typically an oxygen atom of an ether or ester linkage, more typically an ether linkage. In some embodiments, the one or more segments include two or more aryl or heteroaryl groups in which at least two of the aryl or heteroaryl groups include an oxygen atom attached to the ring and a substituent group (preferably a “bulky” substituent group) attached to the ring preferably at an ortho or meta position relative to the oxygen atom. Non-limiting examples of such materials having ortho substituent groups include tetramethyl bisphenol F (TMBPF), diepoxides of TMBPF, and polymers formed therefrom. Examples of suitable such polymers are described in U.S. Pat. Pub. No. 2013/0316109 (Niederst et al.).

Examples of commercially available polyester film-forming polymers that are suitable for use in coating compositions of the present disclosure include saturated polyesters available under the trade names DYNAPOL L, LH, and LS (Degussa AG, 45764 Marl, Germany), amorphous copolyesters available under the trade names VYLON GK330 and GK640 (Toyobo Co. Ltd., Osaka 530-8230, Japan), saturated thermoplastic polyesters available under the trade names SYNOLAC 75 NA 64 (medium molecular weight) and SYNOLAC 0691 S 60 (high molecular weight) (both available from Cray Valley, F-92091 Paris La Defense Cedex, France), alkyd type polyester resins, for example, those commercially available under the trade names URALAC AN621 S-2 60 and URALAC AN637 S-2 60 (available from DSM Neoresins BV, 5140 AC Waalwijk, Netherlands), and other polyesters available under the trade names DESMOPHEN T 1665 SN/IB and RUCOTE 552 (both available from Bayer Material Science AG, D-51368, Leverkusen, Germany) as well as URALAC SN800 S2G3-60, URALAC SN852 S2F-60, and URALAC SN859 S2G3-50 (all available from DSM Neoresins BV, 5140 AC Waalwijk, Netherlands).

Acrylic film-forming polymers that are suitable for use in coating compositions of the present invention include the reaction products of a composition that includes a (meth)acrylic acid ester, an ethylenically unsaturated mono- or multi-functional acid, and an optional vinyl compound. For example, the acrylate film-forming polymer could be a reaction product of components that include ethyl acrylate, acrylic acid, and styrene (preferably in the presence of 2,2′-azobis(2-methyl-butyronitrile) and tert-butyl peroxybenzoate free radical initiators).

Examples of suitable (meth)acrylic acid esters (i.e., methacrylic acid esters and acrylic acid esters) include methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, isoamyl (meth)acrylate, hexyl (meth)acrylate, 2-hydroxyethyl (meth)acrylate, 2-ethylhexyl (meth)acrylate, cyclohexyl (meth)acrylate, decyl (meth)acrylate, isodecyl (meth)acrylate, benzyl (meth)acrylate, 2-hydroxypropyl (meth)acrylate, lauryl (meth)acrylate, isobornyl (meth)acrylate, octyl (meth)acrylate, and nonyl (meth)acrylate.

Examples of suitable ethylenically unsaturated mono- or multi-functional acids include methacrylic acid, acrylic acid, crotonic acid, itaconic acid, maleic acid, mesaconic acid, citraconic acid, sorbic acid, and fumaric acid.

Examples of suitable vinyl compounds include styrene, halostyrene, isoprene, a conjugated butadiene, alpha-methylstyrene, vinyl toluene, vinyl naphthalene, vinyl chloride, acrylonitrile, methacrylonitrile, vinyl acetate, vinyl propionate, vinyl cyclohexane, vinyl cyclooctane, vinyl cyclohexene, and vinyl stearate.

Examples of commercially available acrylic film-forming polymers that are suitable for use in coating compositions of the present disclosure include those available under the trade names VIACRYL SC 454/50BSNB, VIACRYL SC383w/50WA, and VANCRYL 2900 DEV (all from Cytec Industries Inc., West Patterson, N.J.), as well as NEOCRYL A-639, NEOCRYL XK-64, URACON CR203 M3, and URACON CS113 S1G (all from DSM Neoresins BV, 5140 AC Waalwijk, Netherlands). Examples of acrylic film-forming polymers can be found in U.S. Pat. No. 7,592,047 (O'Brien) and U.S. Pat. No. 7,189,787 (O'Brien).

Examples of suitable polyolefin film-forming polymers for use in coating compositions of the present disclosure include maleic-modified polyethylene, maleic-modified polypropylene, ethylene acrylic acid copolymers, ethylene methacrylic acid copolymers, propylene acrylic acid copolymers, propylene methacrylic acid copolymers, and ethylene vinyl alcohol copolymers.

Examples of commercially available polyolefin film-forming polymers that are suitable for use in coating compositions of the present disclosure include those available under the trade names DOW PRIMACOR 5980i, DUPONT NUCREL, POLYBOND 1103, NIPPON SOARNOL (EVOH), ARKEMA OREVAC 18751, and ARKEMA OREVAC 18360. Examples of polyolefin film-forming polymers can be found in U.S. Pat. No. 9,000,074 (Choudhery), U.S. Pat. No. 8,791,204 (Choudhery), and International Pub. No. WO 2014/140057 (Akzo Nobel) and U.S. Pat. No. 8,722,787 (Romick et al.), U.S. Pat. No. 8,779,053 (Lundgard et al.), and U.S. Pat. No. 8,946,329 (Wilbur et al.).

In certain embodiments, the film-forming polymer is a polyether (e.g., an aromatic polyether). In certain embodiments, the polyether film-forming polymer has a Tg of greater than Tg of up to 150° C., or up to 110° C. In certain embodiments, the polyether film-forming polymer is made from the reaction of a diepoxide of an ortho-substituted diphenol group-containing compound (e.g., the diglycidyl ether of tetra-methyl-bisphenol F) with an extender (e.g., a diphenol group-containing compound such as hydroquinone, or a diacid). Examples of suitable such polymers are described in U.S. Pat. Pub. No. 2013/0316109 (Niederst et al.). Examples of suitable polyether polymers (BPA free) are disclosed in U.S. Pat. No. 9,409,219 (Niederst et al.), U.S. Pat. Pub. No. 2013/0206756 (Niederst et al.), U.S. Pat. Pub. No. 2015/0021323 (Niederst et al.), International Pub. Nos. WO 2015/160788 (Valspar Sourcing), WO 2015/164703 (Valspar Sourcing), WO 2015/057932 (Valspar Sourcing), and WO 2015/179064 (Valspar Sourcing).

For aqueous coating compositions, preferred film-forming polymers are polyether-acrylic film-forming polymers, wherein the acrylate (i.e., acrylic) portion provides water-dispersing groups. In certain embodiments, the polyether-acrylic polymers are latex polymers.

### Container Coating Compositions

In certain embodiments, the container coating compositions of the present disclosure are substantially free of bisphenol A, bisphenol F, and bisphenol S, as well as structural units derived therefrom. Preferably, the container coating compositions are substantially free of structural units derived from all bisphenol compounds (including non-estrogenic bisphenol compounds), as well as structural units derived therefrom. As used herein, the term “substantially free” means that the container coating compositions of the present disclosure contain less than 1000 parts per million (ppm) of bisphenol A, bisphenol F, and bisphenol S, as well as structural units derived therefrom (in total), or preferably of all bisphenol compounds, as well as structural units derived therefrom (in total).

In certain embodiments, the container coating compositions are essentially free of bisphenol A, bisphenol F, and bisphenol S, as well as structural units derived therefrom. In certain preferred embodiments, the container coating compositions are essentially free of all bisphenol compounds (including non-estrogenic bisphenol compounds), as well as structural units derived therefrom. As used herein, the term “essentially free” means that the container coating compositions of the present disclosure contain than 100 ppm of bisphenol A, bisphenol F, and bisphenol S, as well as structural units derived therefrom (in total), or preferably of all bisphenol compounds, as well as structural units derived therefrom (in total).

In certain embodiments, the container coating compositions are essentially completely free of bisphenol A, bisphenol F, and bisphenol S, as well as structural units derived therefrom. In certain preferred embodiments, the container coating compositions are essentially completely free of all bisphenol compounds (including non-estrogenic bisphenol compounds), as well as structural units derived therefrom. As used herein, the term “essentially completely free” means that the container coating compositions of the present disclosure contain less than 5 ppm of bisphenol A, bisphenol F, and bisphenol S, as well as structural units derived therefrom (in total), or preferably of all bisphenol compounds, as well as structural units derived therefrom (in total).

In certain embodiments, the container coating compositions are completely free of bisphenol A, bisphenol F, and bisphenol S, as well as structural units derived therefrom. In certain preferred embodiments, the container coating compositions are completely free of all bisphenol compounds (including non-estrogenic bisphenol compounds), as well as structural units derived therefrom. As used herein, the term “completely free” means that the container coating compositions of the present disclosure contain less than 20 ppb of bisphenol A, bisphenol F, and bisphenol S, as well as structural units derived therefrom (in total), or preferably of all bisphenol compounds, as well as structural units derived therefrom (in total).

In certain embodiments, the container coating compositions of the present disclosure include a substantial amount of water and may further include one or more optional organic solvents. Such compositions are referred to herein as aqueous coating compositions. In some embodiments, water constitutes greater than 20% by weight (i.e., wt-%), more preferably greater than 35% by weight, and even more preferably greater than 50 wt-%, of the total weight of the aqueous carrier. In some embodiments, water constitutes 100 wt-% or less, less than 95 wt-%, or less than 90 wt-% of the total weight of the aqueous carrier.

In certain embodiments, the container coating compositions of the present disclosure includes one or more organic solvents, and 0 to 2 wt-% water. Such compositions are referred to herein as solvent-based coating compositions.

Whether in the aqueous carrier of an aqueous coating composition or in a solvent-based coating composition, suitable organic solvents include ketones, glycol ethers, esters, alcohols, aromatics, and combinations thereof. Examples of such solvents include cyclohexanone, carbitol, butyl carbitol, butylcellosolve, butanol, methyl isobutyl ketone, methyl isoamyl ketone, methyl amyl ketone, xylene, aromatic 150, aromatic 100, hexylcellosolve, toluene, propylene glycol monomethyl ether acetate, propylene glycol monomethyl ether, dibasic ester, ethyl carbitol, diisobutyl ketone, and mixtures thereof.

In certain embodiments, the container coating compositions (whether aqueous or solvent-based) may include an acid catalyst to make the overall coating a thermoset coating. Examples of acid catalysts include those selected from the group of phosphoric acid, dodecylsulfonic acid, paratoluenesulfonic acid, and a combination thereof.

In certain embodiments, such as for certain spray coating applications (e.g., inside spray for food or beverage containers including, e.g., aluminum beverage cans), an aqueous coating composition includes solids in an amount of at least 5 wt-%, at least 10 wt-%, or at least 15 wt-%, based on total weight of the aqueous composition. In certain embodiments, the aqueous composition includes solids in an amount of up to 40 wt-%, up to 35 wt-%, up to 30 wt-%, or up to 25 wt-%, based on total weight of the aqueous composition. The aqueous carrier may constitute the remainder of the weight of the aqueous composition.

In certain embodiments, the container coating compositions of the present disclosure may further include an additive selected from a lubricant (e.g., carnauba wax, synthetic wax, polytetrafluoroethylene wax, polyethylene wax, and polypropylene wax), a pigment (e.g., titanium dioxide, carbon black), or a combination thereof. Such additives may be used in amounts typically known to those of skill in the art.

In certain embodiments, an aqueous coating composition of the present includes zinc oxide for stain hiding. In certain embodiments, the zinc oxide is present in an amount of at least 0.7 wt-%, based on the solids of the coating composition. In certain embodiments, the zinc oxide is present in an amount of up to 75.2 wt-%, based on the solids of the coating composition.

Use of coating compositions of the present disclosure include: providing a coating composition as described herein; applying the coating composition to at least a portion of a metal substrate prior to or after forming the metal substrate into a food or beverage container (e.g., a can) or portion thereof; and thermally curing the coating composition.

In certain embodiments of such methods, the metal substrate includes a steel or aluminum substrate. In certain embodiments of such methods, the coating composition is applied to a preformed food or beverage container or a portion thereof. That is, in certain embodiments, the metal substrate is in the form of a preformed food or beverage can having a sidewall and a bottom end, and spraying comprises spraying an interior surface of the sidewall and bottom end.

In certain embodiments of such methods, the coating composition is applied to a food- or beverage-contact surface of the metal substrate (e.g., an interior side of a food or beverage container or a surface that will become an interior side of a food or beverage container). Thus, methods of the present disclosure can involve applying the coating composition to a flat substrate, and then forming the flat metal substrate into at least a portion of a food or beverage container after thermally curing the coating composition.

In certain embodiments of such methods, applying the coating composition includes spraying the coating composition on the metal substrate in an amount sufficient to form a cured coating having an average dry film weight of 1 mg/in² (i.e., 1.55 g/m²) to 20 mg/in² (i.e., 31 g/m²).

The disclosed coating compositions may be present as a layer of a mono-layer coating system or as one or more layers of a multi-layer coating system. The coating compositions can be used as a primer coat, an intermediate coat, a top coat, or a combination thereof. The coating thickness of a particular layer and of the overall coating system will vary depending upon the coating material used, the substrate, the coating application method, and the end use for the coated article. In certain embodiments, a coating prepared from a coating composition of the present disclosure, particularly if an inside container coating, has an average coating thickness of at least 1 micron, and often up to 20 microns.

Mono-layer or multi-layer coating systems including one or more layers formed from the disclosed coating compositions may have any suitable overall coating thickness, and typically are applied, using the mixed units commonly employed in the packaging industry, at coating weights of 1 milligram per square inch (mg/in² or msi) (i.e., 1.55 gram per square meter (g/m²)) to 20 mg/in² (i.e., 31 g/m²), and more typically at 1.5 mg/in² to 10 mg/in²(i.e., 2.3 g/m² to 15.5 g/m²). That is, in certain embodiments, the cured coating has an average dry film weight of 1 mg/in² (i.e., 1.55 g/m²) to 20 mg/in² (i.e., 31 g/m²). Typically, the cured coating weight for rigid metal food or beverage container applications are 1 mg/in² (i.e., 1.55 g/m²) to 6 mg/in² (i.e., 9.3 g/m²). In certain embodiments in which a coating composition of the present disclosure is used as an interior coating on a drum (e.g., a drum for use with food or beverage products), the coating weight may be approximately 20 mg/in² (i.e., 31 g/m²).

The metal substrate used in forming rigid food or beverage containers, or portions thereof, typically has a thickness in the range of 125 microns to 635 microns. Electro tinplated steel, cold-rolled steel, and aluminum are commonly used as metal substrates for food or beverage containers, or portions thereof. In embodiments in which a metal foil substrate is employed in forming, e.g., a packaging article, the thickness of the metal foil substrate may be even thinner that that described above.

The disclosed coating compositions may be applied to a substrate either prior to, or after, the substrate is formed into an article such as, for example, a food or beverage container or a portion thereof. In one embodiment, a method of forming food or beverage containers is provided that includes: applying (via spray application, dipping, etc.) a coating composition described herein to a metal substrate (e.g., applying the composition to the metal substrate in the form of a planar coil or sheet), thermally curing the coating composition, and forming (e.g., via stamping) the substrate into a packaging container or a portion thereof (e.g., a food or beverage container or a portion thereof). For example, two-piece or three-piece cans or portions thereof such as riveted beverage can ends (e.g., soda or beer cans) with a cured coating of the disclosed coating composition on a surface thereof can be formed in such a method.

As described above, the disclosed coating compositions are particularly well adapted for use on food and beverage cans (e.g., two-piece cans, three-piece cans, etc.). Two-piece cans are manufactured by joining a can body (typically a drawn metal body) with a can end (typically a drawn metal end). The disclosed coatings are suitable for use in food or beverage contact situations and may be used on the inside of such cans (e.g., as a continuous inside spray coating, for example, on a food- or beverage-contact surface of a metal substrate). They are particularly suitable for being spray applied, liquid coatings for the interior side of an article (e.g., two-piece drawn and ironed aluminum beverage cans and coil coatings for beverage can ends). The disclosed coating compositions also offer utility in other applications. These additional applications include, but are not limited to, wash coating, sheet coating, and side seam coatings (e.g., food can side seam coatings).

In certain embodiments, the coating compositions are preferably used for food containers, particularly as an internal coating (e.g., inside spray coating) of a food container (especially a food can). Thus, in one embodiment of the present disclosure, a food container is provided that includes a metal substrate having a surface (preferably an inside surface) at least partially coated with a coating including the reaction product of components that include a film-forming polymer and a resole phenolic resin as disclosed herein. In certain embodiments, such food container includes a fatty food. In this context, a fatty food is one that has at least 1.7% fat, based on the weight of the soup. Typically, such fatty foods are more corrosive than beverages.

Examples of such fatty foods include soups, particularly condensed soups, such as cream of mushroom soup, cheddar cheese soup, chicken noodle soup, New England clam chowder, cream of potato soup, beef broth, and split pea with ham soup.

Spray coating methods include the introduction via spraying of a coating composition onto a surface, e.g., into the inside of a preformed packaging container. Typical preformed packaging containers suitable for spray coating include food containers, beer and beverage containers, and the like. The spray preferably utilizes a spray nozzle capable of uniformly coating the inside of the preformed packaging container. The sprayed preformed container is then subjected to heat to remove the carrier (i.e., water and/or organic solvents) and harden the coating.

A coil coating is described as the coating of a continuous coil composed of a metal (e.g., steel or aluminum). Once coated, the coating coil is subjected to a short thermal, ultraviolet or electromagnetic curing cycle, for hardening (e.g., drying and curing) of the coating. Coil coatings provide coated metal (e.g., steel or aluminum) substrates that can be fabricated into formed articles, such as two-piece drawn food cans, three-piece food cans, food can ends, drawn and ironed cans, beverage can ends, and the like.

For any of the application techniques described above, the curing process may be performed in either discrete or combined steps. For example, substrates can be dried at ambient temperature to leave the coating composition in a largely uncrosslinked state. The coated substrates can then be heated to fully cure the compositions. In certain instances, the disclosed coating compositions may be dried and cured in one step. The cure conditions will vary depending upon the method of application and the intended end use. The curing process may be performed at any suitable temperature, including, for example, oven temperatures in the range of from 350° F. to 480° F., and more typically from 375° F. to 450° F., for a time period of 10 seconds to 20 minutes, and more typically for a time period of 30 seconds to 10 minutes. If the substrate to be coated is a metal coil, curing of the applied coating composition may be conducted, for example, by heating the coated metal substrate over a suitable time period to a peak metal temperature (“PMT”) of preferably greater than 177° F. More preferably, the coated metal coil is heated for a suitable time period (e.g., 5 to 900 seconds) to a PMT of at least 218° F. Other commercial coating application and curing methods are also envisioned, for example, electrocoating, extrusion coating, laminating, powder coating, and the like.

### EXEMPLARY EMBODIMENTS

Embodiment 1 is a food or beverage container (which includes within its scope containers such as a can, pail, or drum) coating composition comprising: a film-forming polymer; and a resole phenolic resin comprising the reaction product of components comprising an aldehyde and a phenol group-containing compound, wherein the phenol group-containing compound comprises one or more phenyl rings (preferably, two or more phenyl rings) and at least two hydroxy groups, each of which is directly bonded to the one or more phenyl rings, and at least four (preferably, at least five) open sites ortho and/or para to the hydroxy groups; wherein the composition is thermally curable.

Embodiment 2 is the container coating composition of embodiment 1 wherein the film-forming polymer is present in a majority amount, based on the total weight of the film-forming polymer and the resole phenolic resin. In certain embodiments, the film-forming polymer is present in an amount of up to 99.5 wt-%, based on the total weight of the film-forming polymer and the resole phenolic resin.

Embodiment 3 is the container coating composition of embodiment 1 or 2 wherein the resole phenolic resin is present in an amount of at least 0.5 wt-%, or at least 1.0 wt-%, based on the total weight of the film-forming polymer and the resole phenolic resin.

Embodiment 4 is the container coating composition of any one of embodiments 1 to 3 wherein the resole phenolic resin is present in an amount of up to 30 wt-%, up to 40 wt-%, less than 50 wt-%, up to 50 wt-%, up to 60 wt-%, up to 70 wt-%, up to 80 wt-%, up to 90 wt-%, up to 95 wt-%, up to 98 wt-%, or up to 99.5 wt-%, based on the total weight of the film-forming polymer and the resole phenolic resin.

Embodiment 5 is the container coating composition of any one of embodiments 1 to 4 wherein the film-forming polymer is substantially free of bisphenol A, bisphenol F, and bisphenol S, as well as structural units derived therefrom (and preferably, the film-forming polymer is substantially free of all bisphenol compounds, including non-estrogenic bisphenol compounds, as well as structural units derived therefrom).

Embodiment 6 is the container coating composition of any one of embodiments 1 to 5 wherein the film-forming polymer has a number average molecular weight of at least 1,000 Da, at least 2,000 Da, or at least 3,000 Da.

Embodiment 7 is the container coating composition of any one of embodiments 1 to 6 wherein the film-forming polymer has a number average molecular weight of up to 20,000 Da, up to 10,000 Da, or up to 7,000 Da.

Embodiment 8 is the container coating composition of any one of embodiments 1 to 7 wherein the film-forming polymer is selected from the group of a polyether, a polyester (e.g., a polyester urethane), an acrylic, a polyolefin, and a combination thereof (including copolymers thereof, e.g., polyether-acrylic).

Embodiment 9 is the container coating composition of embodiment 8 wherein the film-forming polymer is a polyether (e.g., an aromatic polyether). Embodiment 10 is the container coating composition of embodiment 9 wherein the polyether has a Tg of greater than 70° C. (or greater than 80° C.).

Embodiment 11 is the container coating composition of any one of embodiments 1 to 10 wherein the aldehyde is selected from the group of formaldehyde, acetaldehyde, crotonaldehyde, benzaldehyde, butyraldehyde, cyclohexanecarboxaldehyde, glutaraldehyde, and a combination thereof.

Embodiment 12 is the container coating composition of embodiment 11 wherein the aldehyde is formaldehyde.

Embodiment 13 is the container coating composition of any one of embodiments 1 to 12 wherein the phenol group-containing compound comprises at least three hydroxy groups (e.g., trisphenol or tetraphenol).

Embodiment 14 is the container coating composition of any one of embodiments 1 to 12 wherein the phenol group-containing compound comprises at least three phenyl rings (e.g., trisphenol or tetraphenol).

Embodiment 15 is the container coating composition of any one of embodiments 1 to 12 wherein the phenol group-containing compound is selected from the group of trisphenol, tetraphenol, catechol, hydroquinone, resorcinol, phloroglucide, 2,7-dihydroxynaphthalene, 1,5-dihydroxynaphthalene, bisphenol M, and a combination thereof.

Embodiment 16 is the container coating composition of embodiment 15 wherein the phenol group-containing compound is selected from the group of trisphenol, tetraphenol, hydroquinone, and a combination thereof.

Embodiment 17 is the container coating composition of embodiment 16 wherein the phenol group-containing compound is selected from the group of trisphenol, tetraphenol, and a combination thereof (in certain embodiments, the phenol group-containing compound is trisphenol).

Embodiment 18 is the container coating composition of any one of embodiments 1 to 17 which has a viscosity of at least 25 centipoise (cps) (25 mPa·s), or at least 50 mPa·s, and, in certain embodiments up to 1000 mPa·s.

Embodiment 19 is the container coating composition of any one of embodiments 1 to 18 wherein the resole phenolic resin is substantially free of bisphenol A, bisphenol F, and bisphenol S, as well as structural units derived therefrom (preferably, the resole phenolic resin is substantially free of all bisphenol compounds (including non-estrogenic bisphenol compounds), as well as structural units derived therefrom).

Embodiment 20 is the container coating composition of any one of embodiments 1 to 19 wherein the composition is thermally curable at a temperature of 350° F. to 480° F.

Embodiment 21 is the container coating composition of embodiment 20 wherein the composition is thermally curable at a temperature of 375° F. to 450° F.

Embodiment 22 is the container coating composition of embodiment 20 or 21 wherein the composition is thermally curable within a period of at least 10 seconds, at least 20 seconds, or at least 30 seconds.

Embodiment 23 is the container coating composition of embodiment 22 wherein the composition is thermally curable within a period of up to 30 minutes, up to 20 minutes, or up to 10 minutes.

Embodiment 24 is the container coating composition of any one of embodiments 1 to 23 wherein the coating composition comprises water (optionally in combination with one or more organic solvents and is an aqueous coating composition).

Embodiment 25 is the container coating composition of embodiment 24 further comprising zinc oxide.

Embodiment 26 is the container coating composition of embodiment 25 wherein the zinc oxide is present in an amount of 0.7 wt-% to 75.2 wt-%, based on the solids of the coating composition.

Embodiment 27 is the container coating composition of any one of embodiments 1 to 23 wherein the coating composition comprises an organic solvent, wherein the coating composition is a solvent-based coating composition that includes 0 to 2 wt-% water.

Embodiment 28 is the container coating composition of any one of embodiments 24 to 27 wherein the organic solvent is selected from include ketones, glycol ethers, esters, alcohols, aromatics, and combinations thereof.

Embodiment 29 is the container coating composition of any one of embodiments 1 to 28 further comprising an acid catalyst.

Embodiment 30 is the container coating composition of embodiment 29 wherein the acid catalyst is selected from the group of phosphoric acid, dodecylsulfonic acid, paratoluenesulfonic acid, and a combination thereof.

Embodiment 31 is the container coating composition of any one of embodiments 1 to 30 further comprising a lubricant (e.g., carnauba wax, synthetic wax, polytetrafluoroethylene wax, polyethylene wax, and polypropylene wax), a pigment (e.g., titanium dioxide, carbon black), or a combination thereof.

Embodiment 32 is the container coating composition of any one of embodiments 1 to 31 which is an inside spray coating.

Embodiment 33 is the container coating composition of any one of embodiments 1 to 32 which is substantially free of bisphenol A, bisphenol F, and bisphenol S, as well as structural units derived therefrom.

Embodiment 34 is the container coating composition of embodiment 33 which is substantially free of all bisphenol compounds, as well as structural units derived therefrom).

Embodiment 35 is a food or beverage container comprising a metal substrate having a surface (in certain embodiments, an inside surface) at least partially coated with a coating comprising the reaction product of components comprising: a film-forming polymer; and a resole phenolic resin comprising the reaction product of components comprising an aldehyde and a phenol group-containing compound, wherein the phenol group-containing compound comprises one or more phenyl rings (preferably, two or more phenyl rings), at least two hydroxy groups, each of which is directly bonded to a phenyl ring, and at least four (preferably at least five) open sites ortho and/or para to the hydroxy groups.

Embodiment 36 is the container of embodiment 35 wherein the film-forming polymer is present in a majority amount, based on the total weight of the film-forming polymer and the resole phenolic resin. In certain embodiments, the film-forming polymer is present in an amount of up to 99.5 wt-%, based on the total weight of the film-forming polymer and the resole phenolic resin.

Embodiment 37 is the container of embodiment 35 or 36 wherein the resole phenolic resin is present in an amount of at least 0.5 wt-%, or at least 1.0 wt-%, based on the total weight of the film-forming polymer and the resole phenolic resin.

Embodiment 38 is the container of any one of embodiments 35 to 27 wherein the resole phenolic resin is present in an amount of up to 30 wt-%, up to 40 wt-%, less than 50 wt-%, up to 50 wt-%, up to 60 wt-%, up to 70 wt-%, up to 80 wt-%, up to 90 wt-%, up to 95 wt-%, up to 98 wt-%, or up to 99.5 wt-%, based on the total weight of the film-forming polymer and the resole phenolic resin.

Embodiment 39 is the container of any one of embodiments 35 to 37 wherein the resole phenolic resin and/or the film-forming polymer is substantially free of bisphenol A, bisphenol F, and bisphenol S, as well as structural units derived therefrom (and preferably, the film-forming polymer is substantially free of all bisphenol compounds, including non-estrogenic bisphenol compounds, as well as structural units derived therefrom).

Embodiment 40 is the container of any one of embodiments 35 to 39 wherein the film-forming polymer has a number average molecular weight of at least 1,000 Da, at least 2,000 Da, or at least 3,000 Da.

Embodiment 41 is the container of embodiment 39 wherein the film-forming polymer has a number average molecular weight of up to 20,000 Da, up to 10,000 Da, or up to 7,000 Da.

Embodiment 42 is the container of any one of embodiments 35 to 41 wherein the film-forming polymer is selected from the group of a polyether, a polyester (e.g., a polyester urethane), an acrylic, a polyolefin, and a combination thereof (including copolymers thereof, e.g., polyether-acrylic).

Embodiment 43 is the container of embodiment 42 wherein the film-forming polymer is a polyether (e.g., an aromatic polyether). Embodiment 44 is the container of embodiment 43 wherein the polyether has a Tg of greater than 70° C. (or greater than 80° C.).

Embodiment 45 is the container of any one of embodiments 35 to 44 wherein the aldehyde is selected from the group of formaldehyde, acetaldehyde, crotonaldehyde, benzaldehyde, butyraldehyde, cyclohexanecarboxaldehyde, glutaraldehyde, and a combination thereof.

Embodiment 46 is the container of embodiment 45 wherein the aldehyde is formaldehyde.

Embodiment 47 is the container of any one of embodiments 35 to 46 wherein the phenol group-containing compound comprises at least three hydroxy groups (e.g., trisphenol or tetraphenol).

Embodiment 48 is the container of any one of embodiments 35 to 46 wherein the phenol group-containing compound comprises at least three phenyl rings (e.g., trisphenol or tetraphenol).

Embodiment 49 is the container of any one of embodiments 35 to 46 wherein the phenol group-containing compound is selected from the group of trisphenol, tetraphenol, catechol, hydroquinone, resorcinol, phloroglucide, 2,7-dihydroxynaphthalene, 1,5-dihydroxynaphthalene, bisphenol M, and a combination thereof.

Embodiment 50 is the container of embodiment 49 wherein the phenol group-containing compound is selected from the group of trisphenol, tetraphenol, hydroquinone, bisphenol M, and a combination thereof.

Embodiment 51 is the container of embodiment 50 wherein the phenol group-containing compound is selected from the group of trisphenol, tetraphenol, and a combination thereof (in certain embodiments, the phenol group-containing compound is trisphenol).

Embodiment 52 is the container of any one of embodiments 35 to 51 further comprising a lubricant (e.g., carnauba wax, synthetic wax, polytetrafluoroethylene wax, polyethylene wax, and polypropylene wax), a pigment (e.g., titanium dioxide, carbon black), or a combination thereof.

Embodiment 53 is the container of any one of embodiments 35 to 52 further comprising a fatty food.

Embodiment 54 is the container of embodiment 53 wherein the fatty food is a soup.

Embodiment 55 is the container of embodiment 54 wherein the soup comprises a condensed soup.

Embodiment 56 is the container of embodiment 55 wherein the condensed soup comprises cream of mushroom soup, cheddar cheese soup, chicken noodle soup, New England clam chowder, cream of potato soup, beef broth, and split pea with ham soup.

Embodiment 57 is the container of any one of embodiments 35 to 56 wherein the coating has an average coating thickness of 1 micron to 20 microns.

Embodiment 58 is the container of any one of embodiments 35 to 57 wherein the coating is substantially free of bisphenol A, bisphenol F, and bisphenol S, as well as structural units derived therefrom.

Embodiment 59 is the container of embodiment 58 wherein the coating is substantially free of all bisphenol compounds, as well as structural units derived therefrom.

Embodiment 60 is a method of coating a food or beverage container, the method comprising: providing a food or beverage container coating composition of any one of embodiments 1 to 34; applying the coating composition to at least a portion of a metal substrate prior to or after forming the metal substrate into a food or beverage container or portion thereof; and thermally curing the coating composition.

Embodiment 61 is the method of embodiment 60 wherein the substrate is a flat substrate, and the method further comprises forming the flat metal substrate into at least a portion of a food or beverage container after thermally curing the coating composition.

Embodiment 62 is the method of embodiment 60 wherein the metal substrate is in the form of at least a portion of a preformed food or beverage container.

Embodiment 63 is the method of any one of embodiments 60 to 62 wherein applying the coating composition comprises spraying the coating composition onto the metal substrate.

Embodiment 64 is the method of embodiment 63 wherein the metal substrate is in the form of a preformed food or beverage container having a sidewall and a bottom end, and spraying comprises spraying an interior surface of the sidewall and bottom end.

Embodiment 65 is a food or beverage container (which includes within its scope containers such as a can, pail, or drum) coating composition comprising a resole phenolic resin (without a distinct film-forming polymer) comprising the reaction product of components comprising an aldehyde and a phenol group-containing compound, wherein the phenol group-containing compound comprises one or more phenyl rings (preferably, two or more phenyl rings) and at least two hydroxy groups, each of which is directly bonded to the one or more phenyl rings, and at least four (preferably, at least five) open sites ortho and/or para to the hydroxy groups; wherein the composition is thermally curable.

Embodiment 66 is a food or beverage container (which includes within its scope containers such as a can, pail, or drum) comprising a metal substrate having a surface (in certain embodiments, an inside surface) at least partially coated with a coating comprising a resole phenolic resin (without a distinct film-forming polymer) comprising the reaction product of components comprising an aldehyde and a phenol group-containing compound, wherein the phenol group-containing compound comprises one or more phenyl rings (preferably, two or more phenyl rings), at least two hydroxy groups, each of which is directly bonded to a phenyl ring, and at least four (preferably at least five) open sites ortho and/or para to the hydroxy groups.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Mo., or may be synthesized by conventional methods. The following abbreviations may be used in the following examples: ppm=parts per million; phr=parts per hundred rubber; mL=milliliter; L=liter; m=meter, mm=millimeter, cm=centimeter, kg=kilogram, g=gram, min=minute, s=second, h=hour, ° C.=degrees Celsius, ° F.=degrees Farenheit, MPa=megapascals, and N-m=Newton-meter, Mn=number average molecular weight, cP=centipoise.

### Test Methods

Unless indicated otherwise, the following test methods may be utilized.

### Differential Scanning Calorimetry for Tg

Samples for differential scanning calorimetry (“DSC”) testing are prepared by first applying the liquid resin composition onto aluminum sheet panels. The panels are then baked in a Fisher Isotemp electric oven for 20 minutes at 300° F. (149° C.) to remove volatile materials. After cooling to room temperature, the samples are scraped from the panels, weighed into standard sample pans, and analyzed using the standard DSC heat-cool-heat method. The samples are equilibrated at −60° C., then heated at 20° C. per minute to 200° C., cooled to −60° C., and then heated again at 20° C. per minute to 200° C. Glass transition temperatures are calculated from the thermogram of the last heat cycle. The glass transition is measured at the inflection point of the transition.

### Viscosity of Coating Composition

ASTM D1200-10 was used for this procedure.

### Molecular Weight Determination by Gel Permeation Chromatography

Samples for Gel Permeation Chromatography (“GPC”) testing are prepared by first dissolving the liquid resin in THF. An aliquot of this solution is then analyzed by GPC along with mixtures of polystyrene (“PS”) standards and an epoxy control (Epon 1009F supplied by Hexion, Inc.). The molecular weights of the samples are calculated after processing the GPC runs and verifying the PS and Epon 1009F standards.

### MEK Solvent Resistance of Coating

The extent of “cure” or crosslinking of a coating is measured as a resistance to solvents, such as methyl ethyl ketone (MEK). This test is performed as described in ASTM D 5402-93. The number of double-rubs (i.e., one back-and-forth motion) is reported. Preferably, the MEK solvent resistance is at least 30 double rubs (DR).

### Adhesion

Adhesion testing is performed to assess whether the coating adheres to the coated substrate. The adhesion test was performed according to ASTM D 3359—Test Method B, using SCOTCH 610 tape, available from 3M Company of Saint Paul, Minn. Adhesion is generally rated on a scale of 0-10 where a rating of “10” indicates no adhesion failure, a rating of “9” indicates 90% of the coating remains adhered, a rating of “8” indicates 80% of the coating remains adhered, and so on. Adhesion ratings of 10 are typically desired for commercially viable coatings.

### Blush Resistance

Blush resistance measures the ability of a coating to resist attack by various solutions. Typically, blush is measured by the amount of water absorbed into a coated film. When the film absorbs water, it generally becomes cloudy or looks white. Blush is generally measured visually using a scale of 0-10 where a rating of “10” indicates no blush and a rating of “0” indicates complete whitening of the film. Blush ratings of at least 7 are typically desired for commercially viable coatings and optimally 9 or above.

### Crazing—Reverse Impact Resistance

The reverse impact measures the coated substrate's ability to withstand the deformation encountered when impacted by a steel punch with a hemispherical head and can be a predicator, e.g., for the ability of a food or beverage container coating to survive a drop can event. For the present evaluation, coated substrate was subjected to 36 inch-pounds (4.07 N m) of force using BYK-Gardner “overall” Bend and Impact Tester and rated visually for micro-cracking or micro-fracturing—commonly referred to as crazing. Test pieces were impacted on the uncoated or reverse side. A rating of 10 indicates no craze and suggests sufficient flexibility and cure. A rating of 0 indicates complete failure. Commercially viable coatings preferably show slight or no crazing on a reverse impact test. In the data reported below in Table 1, “w” refers to portions of the coated strip immersed in water and “wv” refers to portions of the coated strip that were exposed to water vapor in the headspace.

### Process Resistance

The process test determines the ability of a coating to withstand elevated temperatures and pressures while in contact with water. Such conditions are frequently present in pasteurization processes used in conjunction with food or beverage products. A coated substrate is typically tested as follows. Strips of coated metal substrate (e.g., 1.5 inch by 7 inch electroplated tin, “ETP” strips) are partially immersed in deionized water, and the partially immersed strips are placed in a pressure cooker and subjected to 90 minutes at elevated pressure suitable to achieve a temperature of 250° F. (121° C.). The coated strips where then tested for coating adhesion and blush as described above. Commercially viable coatings preferably provide adequate process resistance with perfect adhesion (rating of 10) and blush ratings of at least 5, optimally at least 9.

### Example 1

### Synthesis of a Resole Phenolic Resin from Trisphenol

To a 4-neck round-bottom flask equipped with a mechanical stirrer, a nitrogen inlet to maintain a nitrogen blanket, a water-cooled condenser, and a thermocouple connected to heating control device and a heating mantle was added 32.21 parts KTN-6130 (Benzaldehyde, hydroxyl-, polymer with phenol (CAS=106466-55-1), Kangnam Chemical, Seoul, Korea), 9.57 parts formalin (37% solids), 0.04 parts calcium hydroxide, and 2.84 parts deionized water. This mixture was heated slowly with stirring to 85° C., allowed to exotherm to 93° C., then heated to 85° C. for 1 hour until the percentage of CH₂O was less than 1%. At this point the mixture was cooled to 55° C. and to the mixture was added 0.08 parts phosphoric acid (85% solids) and 14.75 parts toluene. After a 15-minute hold at 55° C., the mixture was heated to 75° C., and to the mixture was added 11.04 parts butanol. Once the reaction mixture reached 75° C., the nitrogen blanket was removed and the flask was set up for vacuum distillation. The reaction mixture underwent vacuum distillation at 600 torr for 30 minutes until 8.9% of the total batch size was collected as distillate. Vacuum was broken and to the reaction mixture was added 11.04 parts butanol. The reaction mixture underwent vacuum distillation at 300 torr for 45 minutes until 15.4% of the total batch size was collected as distillate. Vacuum was broken and to the reaction mixture was added 18.45 parts butanol while the mixture was cooled to 25° C. The batch was discharged and filter-pressed using Celite media affording a solvent-based resin with a nonvolatile content (“NVC”) of 54%. The phenolic resin had a number average molecular weight (Mn) of 970 by GPC (gel permeation chromatography) and a Gardner-Holdt viscosity of Q run at 77° F. using ASTM D1545-13.

### Example 2

### Synthesis of a Resole Phenolic Resin from Tetraphenol

To a 4-neck round-bottom flask equipped with a mechanical stirrer, a nitrogen inlet to maintain a nitrogen blanket, a water-cooled condenser, and a thermocouple connected to heating control device and a heating mantle was added 32.97 parts Durite SD-357B (ethane, tetrakis (hydroxyphenyl)-(CAS=123246-61-7), Hexion, Inc., Columbus, Ohio), 8.63 parts formalin (37% solids), 0.04 parts calcium hydroxide, and 2.81 parts deionized water. This mixture was heated slowly with stirring to 90° C., allowed to exotherm to 96° C., then heated to 90° C. for 4. hours until the percentage of CH₂O was less than 3%. At this point the mixture was cooled to 55° C. and to the mixture was added 0.08 parts phosphoric acid (85% solids) and 14.66 parts toluene. After a 15 minute hold at 55° C., the mixture was heated to 75° C. and to the mixture was added 10.98 parts butanol. Once the reaction mixture reached 75° C., the nitrogen blanket was removed and the flask was set up for vacuum distillation. The reaction mixture underwent vacuum distillation at 350 torr for 30 minutes until 6.8% of the total batch size was collected as distillate. Vacuum was broken and to the reaction mixture was added 10.98 parts butanol. The reaction mixture underwent vacuum distillation at 250 torr for 45 minutes until 7.0% of the total batch size was collected as distillate. Vacuum was broken and to the reaction mixture was added 18.86 parts butanol while the mixture was cooled to 25° C. The batch was discharged and filter-pressed using Celite media affording a solvent-based resin with a nonvolatile content (“NVC”) of 52%. The phenolic resin had an Mn of 840 by GPC and a Gardner-Holdt viscosity of L run at 77° F. using ASTM D1545-13.

### Example 3

### Synthesis of a Solution Acrylic

To a 4-neck round-bottom flask equipped with a mechanical stirrer, a nitrogen inlet to maintain a nitrogen blanket, and a water-cooled condenser was added 111.27 parts methacrylic acid, 55.63 parts styrene, 18.54 parts ethyl acrylate, 1.628 parts butanol, 8.35 parts benzoyl peroxide, and 3.58 parts deionized water. These materials were stirred for uniformity and then 10.19% of this mixture was charged to a separate 4-neck round-bottom flask equipped with a mechanical stirrer, a nitrogen inlet to maintain a nitrogen blanket, a water-cooled condenser, and a thermocouple connected to a heating control device and a heating mantle. To this mixture was added 76.83 parts butanol and 6.41 parts deionized water. To the mixture in the first 4-neck round-bottom flask was added 111.16 parts butanol and 8.90 parts deionized water. The mixture in the second 4-neck round-bottom flask was heated to 95° C. After 15 minutes at 95° C., the mixture from the first 4-neck round-bottom flask was added to the second 4-neck round-bottom flask over a two-hour period. After the addition was complete, the mixture containing all of the contents from the first 4-neck round-bottom flask and the second 4-neck round-bottom flask was held at 95° C. for a period of 150 minutes. Finally, was added 16.12 parts butanol and 52.17 parts butyl cellosolve and the reaction mixture was cooled to 40° C. The solution acrylic yielded an acid-functional acrylic having a NVC of about 39% and an acid value of about 390 mg KOH/gram.

### Example 4

### Synthesis of a Water-Dispersible Polyether Polymer

To a 4-neck round-bottom flask equipped with a mechanical stirrer, a nitrogen inlet to maintain a nitrogen blanket, a water-cooled condenser, and a thermocouple connected to a heating control device and a heating mantle was added 446.58 parts of the diepoxide in Example 1 of International Patent Publication No. WO 2017/079437 (i.e., the liquid diglycidyl ether of 4,4′-methylenebis(2,6-dimethylphenol)), 107.57 parts of hydroquinone, 0.16 parts CATALYST 1201 (from Shell), 16.11 parts hexyl cellosolve, and 13.04 parts methyl isobutyl ketone (MIXTURE 1). To a separate 4-neck round-bottom flask equipped with a mechanical stirrer, a nitrogen inlet to maintain a nitrogen blanket, a water-cooled condenser, and a thermocouple connected to a heating control device and a heating mantle was added 427.52 parts of the diepoxide in Example 1 of International Patent Publication No. WO 2017/079437 (i.e., the liquid diglycidyl ether of 4,4′-methylenebis(2,6-dimethylphenol)), 126.64 parts of hydroquinone, 0.24 parts CATALYST 1201 (from Shell), 17.71 parts butyl cellosolve, and 16.24 parts methyl isobutyl ketone (MIXTURE 2). Both mixtures were heated to 160° C., allowed to exotherm to 175° C., cooled to and maintained at 160° C. MIXTURE 1 was heated at 160° C. for 2 hours until the epoxy value of 0.035 eq/100 g was achieved, at which point was added 119.12 parts butyl cellosolve and 100.58 parts butanol. MIXTURE 2 was heated at 160° C. for 4 hours until the epoxy value of 0.004 eq/100 g was achieved. MIXTURE 1 and MIXTURE 2 were combined and mixed at 120° C. for 30 minutes and homogeneity. To this combined mixture was added the acrylic polymer from Example 3. This mixture was cooled to 100° C. and was added 98.13 parts butyl cellosolve and 41.82 parts deionized water. At 100° C., to the mixture was added 29.63 parts dimethylethanolamine (“DMEOA”) over 5 minutes. The mixture was then stirred for 2 hours maintaining 100° C. At the end of 2 hours, was added 18.62 parts DMEOA to the mixture over 5 minutes. Finally, was added 1949.70 parts deionized water and the reaction mixture was cooled to 40° C. The water-dispersible polymer yielded a water-based dispersion having a NVC of about 34% and an acid value of about 45 mg KOH/gram.

### Example 5

### Coating Compositions

A packaging coating composition, and more specifically a packaging coating composition for use on the interior or exterior of a food or beverage container, may be formulated pursuant to the methods and materials included herein using the phenolic resin. Under agitation in a 1-ounce, glass jar, a water-dispersible polyether polymer was added from Example 4. To the polymer was added the phenolic resin from Example 1 and the mixture was stirred for 10 minutes for uniformity. After 10 minutes, water was added to afford the final coating composition with a nonvolatile content (“NVC”) of 28.5% and a viscosity of 25″ with a #4 Ford Cup. In the case of the control sample without phenolic resin added, a 2/1 ratio of butyl cellosolve/butanol was added to achieve the same NVC. Under agitation in a 1-ounce, glass jar, a water-dispersible polyether polymer was added from Example 4. To the polymer was added the phenolic resin from Example 2 and the mixture was stirred for 10 minutes for uniformity. After 10 minutes, water was added to afford the final coating composition with a nonvolative content (NVC) of 28.5% and a viscosity of 24″ with a #4 Ford Cup. In the case of the control sample without phenolic resin added, a 2/1 ratio of butyl cellosolve/butanol was added to achieve the same NVC.

Table 1 below shows the film properties of the phenolic resin, when formulated with the water-dispersible polyether polymer from Example 4. The coating compositions of Runs 1-2 were applied to 0.25 75# ETP substrate (ETP is enamel tin plate and was used in all evaluations, available from a variety of sources such as Titan Steel, Baltimore, Md. and New Lenox, Ill.) and cured for 3.5 minutes in a 425° F. (218° C.) box oven to yield a cured coating having the indicated dry film weight.

TABLE 1

| | Run 1 | Run 2 | Run 3 |
|---|---|---|---|
| | Wt-% | Wt-% | Wt-% |
| Material | | | |
| Water-based Polymer | 88.18 | 70.69 | 70.56 |
| from Example 4 | | | |
| (34.0%) | | | |
| Phenolic Resin from | — | 10.43 | — |
| Example 1 (54.3%) | | | |
| Phenolic Resin from | — | — | 10.43 |
| Example 2 (52.2%) | | | |
| Deionized Water | 8.78 | 18.88 | 19.01 |
| 2/1 Butyl Cellosolve/ | 3.04 | — | — |
| Butanol | | | |
| Total: | 100.00 | 100.00 | 100.00 |
| NVC: | 28.5% | 28.5% | 28.5% |
| Resin/Resole phenolic | 100/0 | 80/20 | 80/20 |
| (solids on solids) | | | |
| Film Performance: | | | |
| Dry Film Wt (msi): | 4.1 | 4.4 | 4.1 |
| Substrate: | .25 75# CDC | .25 75# CDC | .25 75# CDC |
| | ETP | ETP | ETP |
| Bake (Box oven): | 3.5′ @ 425° F. | 3.5′ @ 425° F. | 3.5′ @ 425° F. |
| Adhesion: | 10 | 10 | 10 |
| Rev Imp Craze | Pass (10) | Pass (10) | Pass (10) |
| (36 in-lbs): | | | |
| Solvent Resistance | 30 | >100 | 70 |
| (Double Rubs): | | | |
| Process | 9/10 | 10/10 | 4/10 |
| (60′ @ 250° F.): | | | |
| Blush (W/V) | | | |
| Adhesion (W/V) | 10/10 | 10/10 | 10/10 |

It can be seen from Table 1 that, when the phenolic resins are added to a water-based polyether polymer, excellent cure and film properties are obtained.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A food or beverage container coating composition comprising:
a film-forming polymer; and
a resole phenolic resin comprising the reaction product of components comprising an aldehyde and a phenol group-containing compound, wherein the phenol group-containing compound comprises two or more phenyl rings, at least two hydroxy groups, each of which is directly bonded to a phenyl ring, and at least five open sites ortho and/or para to the hydroxy groups;
wherein the composition is thermally curable.

2. The container coating composition of claim 1 wherein the film-forming polymer is present in a majority amount, based on the total weight of the film-forming polymer and the resole phenolic resin.

3. The container coating composition of claim 1 wherein the film-forming polymer is present in an amount of up to 99.5 wt-%, based on the total weight of the film-forming polymer and the resole phenolic resin.

4. The container coating composition of claim 1 wherein the resole phenolic resin is present in an amount of at least 0.5 wt-%, based on the total weight of the film-forming polymer and the resole phenolic resin.

5. The container coating composition of claim 1 wherein the resole phenolic resin and/or the film-forming polymer is substantially free of bisphenol A, bisphenol F, and bisphenol S, as well as structural units derived therefrom.

6. The container coating composition of claim 1 wherein the film-forming polymer is selected from the group of a polyether, a polyester, an acrylic, a polyolefin, and a combination thereof.

7. The container coating composition of claim 1 wherein the aldehyde is selected from the group of formaldehyde, acetaldehyde, crotonaldehyde, benzaldehyde, butyraldehyde, cyclohexanecarboxaldehyde, glutaraldehyde, and a combination thereof.

8. The container coating composition of claim 1 wherein the phenol group-containing compound comprises at least three hydroxy groups.

9. The container coating composition of claim 1 wherein the phenol group-containing compound comprises at least three phenyl rings.

10. The container coating composition of claim 1 wherein the phenol group-containing compound is selected from the group of trisphenol, tetraphenol, and a combination thereof.

11. The container coating composition of claim 1 wherein the composition is thermally curable at a temperature of 350° F. to 480° F.

12. The container coating composition of claim 1 which is substantially free of bisphenol A, bisphenol F, and bisphenol S, as well as structural units derived therefrom.

13. A food or beverage container comprising a metal substrate having a surface at least partially coated with a coating comprising the reaction product of components comprising:
a film-forming polymer; and
a resole phenolic resin comprising the reaction product of components comprising an aldehyde and a phenol group-containing compound, wherein the phenol group-containing compound comprises two or more phenyl rings, at least two hydroxy groups, each of which is directly bonded to a phenyl ring, and at least five open sites ortho and/or para to the hydroxy groups.

14. The container of claim 13 wherein the film-forming polymer is present in a majority amount, based on the total weight of the film-forming polymer and resole phenolic resin.

15. The container of claim 13 wherein resole phenolic resin and/or the film-forming polymer is substantially free of bisphenol A, bisphenol F, and bisphenol S, as well as structural units derived therefrom.

16. The container of claim 13 wherein the aldehyde is selected from the group of formaldehyde, acetaldehyde, crotonaldehyde, benzaldehyde, butyraldehyde, cyclohexanecarboxaldehyde, glutaraldehyde, and a combination thereof.

17. The container of claim 13 wherein the phenol group-containing compound is selected from the group of trisphenol, tetraphenol, and a combination thereof.

18. The container of claim 13 further comprising a fatty food.

19. A method of coating a food or beverage container, the method comprising:
providing a food or beverage container coating composition of claim 1;
applying the coating composition to at least a portion of a metal substrate prior to or after forming the metal substrate into a food or beverage container or portion thereof; and
thermally curing the coating composition.

20. The method of claim 19 wherein the substrate is a flat substrate, and the method further comprises forming the flat metal substrate into at least a portion of a food or beverage container after thermally curing the coating composition.
